(19) United States
(12) Patent Application Publication
(10) Pub. No.: US 2005/0241418 A1
(43) Pub. Date: Nov. 3, 2005

(54) Inertia drive device, unit having the device and method for moving the device

(75) Inventors: Joachim Damrath, Bachhagel (DE); Markus Spielmannleitner, Ellwangen (DE); Gerhard Wetzl, Sontheim (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 11/143,840

(22) Filed: Jun. 2, 2005

Related U.S. Application Data
(63) Continuation of application No. PCT/EP03/12960, filed on Nov. 19, 2003.

(30) Foreign Application Priority Data
Dec. 2, 2002 (DE) 102 56 091.9

(51) Int. Cl. H02N 2/00

(52) U.S. Cl. 74/84 S

(57) ABSTRACT

A motor-driven mobile device has an inertial drive which overcomes static friction between the device and a surface by inertial mass movements and resulting inertial forces in specific phases and recycling the inertial mass movements in other phases, without the static friction being overcome. A unit for regenerating the mobile device and a method for moving the device over a surface, are also provided.

### CROSS-REFERENCE TO RELATED APPLICATIONS

This is a continuing application, under 35 U.S.C. § 120, of copending International Application No. PCT/EP2003/012960, filed Nov. 19, 2003, which designated the United States; this application also claims the priority, under 35 U.S.C. § 119, of German Patent Application 102 56 091.9, filed Dec. 2, 2002; the prior applications are herewith incorporated by reference in their entirety.

### BACKGROUND OF THE INVENTION

Field of the Invention

The present invention relates to a motor-driven inertia drive device, which can be moved over a surface through the use of a drive. The invention also relates to a unit having the device and a method for moving the device.

### SUMMARY OF THE INVENTION

It is accordingly an object of the invention to provide an inertia drive device, a unit having the device and a method for moving the device, which overcome the disadvantages of the heretofore-known devices and methods of this general type.

These can be a wide range of devices. The chief object of the invention is the structure of the drive. By way of example, the device could be a vehicle, a tool or the like. The invention is, however, preferably aimed at a device for treating, in particular cleaning and/or wiping, surfaces. The device according to the invention can, for example, be a motor-driven wiping device for automatic and motorized cleaning of interior room floors.

The technical problem underlying the invention is to provide a device which is moved by a drive and has an improved drive.

With the foregoing and other objects in view there is provided, in accordance with the invention, a device, comprising a base and a drive for moving the base over a surface. The drive has a motor-driven inertial mass movable relative to the base. The drive drives the base by executing movements of the inertial mass relative to the base. The drive overcomes static friction holding the base on the surface by mass inertia or reactance of the inertial mass in a part of the movements of the inertial mass. The drive does not overcome static friction holding the base on the surface in another part of the movements of the inertial mass. The drive causes the movements of the inertial mass relative to the base to be altogether iterative.

With the objects of the invention in view, there is additionally provided a method for moving a device over a surface. The method comprises executing movements of the inertial mass relative to the base with the motor drive of the device according to the invention. Static friction holding the device onto the surface is overcome by mass inertia or reactance of the inertial mass in a part of the movements of the inertial mass, and the static friction holding the device onto the surface is not overcome in another part of the movements of the inertial mass. The device is moved over the surface by iterative movements of the inertial mass relative to the base.

Preferred embodiments of the invention are recited in the dependent claims and in the following description. The invention also relates to a method for wiping floors. However, there is no individual distinction made in the following description between the device and the process of the invention, so that the entire disclosure is to be understood with respect to both categories.

The device according to the invention is distinguished by a novel inertial drive mass. In this case, mass inertia or reactance forces are utilized, which occur from relative movements between an inertial mass and a base to a certain degree forming the solid constituent of the device. These mass inertia or reactance forces in certain phases result in overcoming static friction holding the device to the surface, on which it is to move. In other phases, however, the mass inertia or reactance forces should not overcome the static friction. Movement phases and adhesion phases will be discussed below in simplified form. Depending on the application system, inertial forces, which partly move the base and partly adhere to the surface, are therefore transferred to the latter through the movements of the inertial mass. Otherwise expressed, the movements of the inertial mass lead to a reaction of the base, because the entire system is constructed to correspond to the conservation of momentum. The conservation of momentum, however, is disturbed by the friction between the device and the surface. In the adhesion phases the base remains on the surface, while in the movement phases it describes a movement on the surface. This is preferably a sliding or skidding movement, and with corresponding static friction in the adhesion phases in wheel bearings or between wheel surfaces and the surface during the movement phases, however, it could also be a roll-away movement.

The movements of the inertial mass relative to the base are iterative and therefore are repeated and thus enable continued movement. A drive concept is thus created requiring no direct form-locking or force-locking between drive components and the surface, on which the device is to be moved. A form-locking connection is one which connects two elements together due to the shape of the elements themselves, as opposed to a force-locking connection, which locks the elements together by force external to the elements.

The device preferably rests on a substantially horizontal surface, although the invention is not restricted thereto. For the sake of clarification, it should still be pointed out that the inertial mass is a device component and should not be utilized by the drive concept according to the invention. An energy coupling is necessary to generate the movement, however the inertial mass should as such remain intact in contrast to recoil propulsion such as, for example, in rocket drives or nozzle drives.

The invention thus enables sliding or rolling progression without coupling between drive unit and transport surface. This can, for example, be of interest if form-locking or force-locking with the transport surface can only be made with difficulty, on fully smooth surfaces, or if there is not supposed to be any contact between drive unit and surface with the cleaning device according to the invention.

There are different basic possibilities for the type of movement between the inertial mass and the base. For one, linear movements are conceivable, in which the inertial mass therefore is moved iteratively to and fro. Through the use of corresponding powerful acceleration or deceleration, inertial forces can be generated, which are above a threshold determined by static friction. In the case of lesser acceleration and deceleration, the device remains inside the static friction limits, so that the inertial mass can be retracted in favor of a fresh movement phase of the device.

In this context it can be of particular interest to provide, in addition to the actual motor drive unit of the inertial mass, energy storage, in particular a mechanical spring, which is charged and discharged with energy during the linear movements of the inertial mass synchronously to these movements. For one, at least portions of the energy used by the motor drive unit can be recovered. Secondly, for example, the acceleration phase provided to overcome the static friction can be relieved by correspondingly large forces by the energy storage, and the motor drive unit itself can serve purely as a return mechanism. Thus, the drive unit could press the inertial mass against the spring force and at the same time stress the spring, at which point the drive unit is switched off and the spring is allowed to accelerate the inertial mass relatively strongly.

Furthermore, rotary movements between the inertial mass and the base are possible. Circular movements are preferred in this case. With rotary and in particular with circular movements there are two possible cases which might also occur jointly in principle. For one, the actual conservation of momentum in the sense of linear impulses, therefore in the sense of centrifugal force, can be utilized. Secondly, the angular conservation of momentum can also be utilized, wherein the base describes an angular momentum whenever the angular momentum of the inertial mass is altered. In the event of linear conservation of momentum being in the foreground, the inertial mass is disposed eccentrically with respect to the rotary movement. If the angular conservation of momentum is to the fore, the inertial mass will lie concentrically with respect to the rotary intrinsic rotation. In each case herein the inertial mass is understood as the center of gravity and not necessarily in its corporeal form. In the first case, therefore, for example increased acceleration of the inertial mass could be used in specific path regions, as in non-circular paths such as sunwheel paths or planet wheel paths, and in the second case, for example by way of contrast with a change in direction of a concentric rotation of the inertial mass of the angular momentum acting on the base. In both cases a “jolt” to the base can be generated, which overcomes the static friction for a specific movement phase.

According to the invention it is anyway not absolutely necessary, or even preferred, that the movement phases, therefore the “jerking movements of the base” caused by the inertial masses, always substantially act in the same direction (including acting in the same direction in the sense of rotary movements). In principle there are also cases conceivable, where static friction is also overcome within the scope of “retrograde steps”, which however altogether lead to a lesser rearwards movement than the desired forward movement. By way of example, the inertia drive could also overcome the static friction limit with inertial forces basically acting in the wrong direction. If the static friction limit in the desired direction is overcome for a longer time or at a greater speed, this does not in principle always stand in the way of progressive motion according to the invention.

It is particularly preferred to also use components of the utilized inertial forces to make use of the static friction between the device and the surface, on which it is to move. Through corresponding configuration of movements, in particular their inclination, the device can become heavier or lighter namely timewise and possibly also placewise. In precise terms it is therefore pressed onto the surface by corresponding inertial forces or relieved in gravity. It is possible in addition to or alternatively to the above-mentioned use of particularly large inertial forces in specific movement phases, to differentiate between movement phases and adhesion phases. By way of example, constant inertial forces in the movement phases can lead to sliding of the device by components acting against gravitational force and in adhesion phases can lead to sticking by components working parallel to gravitational force.

The use of at least two inertial masses in the above sense is of particular preference. In addition to the above-mentioned aspects, this allows a skilful combination of the respective inertial forces and respective phasewise addition or compensation. By way of example, two inertial masses with eccentric center of gravity moving in a circle can move in opposite directions and synchronously, so that their inertial forces compensate twice per full revolution and add twice per full revolution. Through additional tilting of the planes of rotation in the phases of addition, in one case gravitation-parallel inertial force components and in another case gravitation-antiparallel inertial force components can be created, so that the device moves jerkily only or at least more strongly in the latter case.

The inertial masses are preferably suspended cardanically on the base in the case of rotary components. This can serve to tilt the rotation planes in the above-described sense. Furthermore, through corresponding adjustment of the cardanic suspension in contrast to a fixed unchangeable tilting, matching to the size of the static friction can also occur between the device and the surface, and in addition possibly necessary compensation of direction dependence of this static friction, for example with aligned wiping cloths. The cardanic suspension is adjusted preferably by motor and at the same time in particular can also happen automatically, in such a way that to a certain degree the device tests the commencement of the movement phase and is adjusted according to given rotation movements by adapting the tilting automatically to an optimal advance drive.

In the case of an inertia drive through using linear conservation of momentum, and therefore centrifugal force as well, it is preferred that the device move over the surface in stages with translatory individual steps, when straight movement of the device is attempted. In contrast to this it is provided when using the angular conservation of momentum to make use of an angular momentum component acting on the base in such a way that an end of the device serves as axis of rotation to a certain extent, and in that it is “loaded” by a surface-parallel angular momentum component acting on the base. In the next step an opposite end of the device can serve as an axis of rotation and an oppositely aligned angular momentum acting on the base, i.e. a component standing perpendicular to the surface, can be used for a corresponding second step. The device would move forward in this case, for example with a right and a left side alternating stepwise and in each case rotating about the other side. The angular momentum components can be generated either by tilting rotating gyroscopes or—less preferred—by accelerating or braking such gyroscopes.

Moreover, the device according to the invention need not necessarily be free of other drive or steering influences. By way of example, in the case of the preferred application as a cleaning device, it can also be desired to provide an exertion of influence of an operator to the movement, for example by applying a style or manner or control for steering or also for supporting movement. A motor-driven wiper with such a style or manner of control would make it easier for cleaning staff on one hand to push the wiper over the surface to be cleaned, while on the other hand the wiper could also be very much heavier and thus more effective with respect to the cleaning action than a conventional manually operated wiper. However, an autonomous and automatically moved cleaning device with the above-mentioned inertia drive is preferred.

The invention focuses in particular on a device for wiping flat surfaces with the above-described motor drive and a wiping surface. In the device, the drive lies inside a web width detected by the wiping surface with movement of the device made by the drive.

With the configuration according to the invention, a drive unit is disposed inside a web width detected by the wiping. This means in particular that the drive unit does not interfere outside the web width covered or detected during wiping, if the wiping is to be done, for example, right along a floor edge. The invention enables this edge to be approached by the wiping surface at a relatively small distance or even without wiping such a distance, because the drive, for example a wheel running between the web width covered or detected by wiping and the floor edge as a drive component, is disposed inside the detected web width.

The invention focuses in particular on the wiping of at least approximately horizontal surfaces, that is those on which the wiping device remains held by gravity during its forward progress. At the same time the drive unit will lie to a considerable extent above the surface to be wiped. In particular, the drive unit is preferably disposed over the wiping surface, however it can also be disposed in the direction of movement in principle before or behind the wiping surface, as long as it remains in the web width.

The invention therefore also offers the possibility to provide a relatively wide wiping surface in relation to the size of the device substantially also determined by the drive unit.

The wiping device according to the invention preferably has narrow and long outer measurements in terms of a projection onto the surface to be wiped, and therefore a clearly greater dimension in one direction than in a second direction perpendicular thereto. The ratio of the dimensions of the longest and the narrowest side is preferably at least 2:1, and better still at least 2.5:1 and in the most favorable case at least 3:1. A preferred basic form of the device in projection onto the surface to be wiped is a long, narrow rectangle. Long, narrow external dimensions on one hand allow a relatively great web width in the case of a not altogether large device on the other hand. In particular, the device can be inserted very flexibly when threaded through narrow passages or when tight corners are being wiped out.

It is further preferred that the above-mentioned external dimensions of the device be determined by the wiping surface, so the wiping surface therefore forms the edges of the device in the plane of the surface to be wiped or at least substantially corresponds to the latter. At the same time it can be optionally provided that the wiping surface thus projects over an exchangeable wiping application, on one or more sides through other parts of the device, and thus for one enables particularly thorough wiping along floor edges and secondly forms a protective impulse edge. Other impulse edges can also naturally be provided, which are not formed by the wiping surface itself. In particular, impulse edges equipped with sensory properties can also be provided to direct automatic control of the wiping device to strike an obstacle and thus cause corresponding control reactions.

When it is operating, the wiping device moves forwards preferably in such a way that during a wiping motion one and the same longitudinal side points forwards. Therefore, the maximal possible web width is used for wiping on one hand and on the other hand the dirt collected during this cleaning is pushed before it. This preferably also applies during and after curved trajectories, so that the wiping device does not leave behind any wiping streaks in corners or curves. In particular, in a for example right-angled corner of a floor, first the wiping device can move with the above-mentioned longitudinal side as far as the skirting board or molding at the opposite edge, then return, rotate about 90° in the direction of the future direction of travel (so that the described longitudinal side now points forwards in the future direction of travel), can move in this rotated position along the edge back to the corner in order to then move on out of the corner in the new direction of travel. At the same time, travel with a forward lying longitudinal side into the corner would be transferred to travel with the same forward lying longitudinal side out of the corner in the new direction of movement.

It can further be provided that as it operates, the wiping surface moves in an oscillating manner relative to the remaining device, for example swings or circles relative to a base of the device in one or even in two horizontal or vertical directions. Thus the mechanical effect on the floor can be increased, without the same path having to be covered repeatedly.

This can be the case in relation to the above-mentioned possibilities of smaller retrograde steps made by the inertia drive during the movement according to the invention. Mechanical reinforcement of the wiping effect can be achieved in such a way that the static friction is overcome for a certain phase during the movement actually striven for both in rearwards or laterally directed movements. In the process, quasi-oscillating (and not necessarily continuous) movements can be attained.

A further structure of the invention provides for equipping the wiping device with a wiping surface not only on one side, but on two opposite sides. The device can then be used by the intervention of an operator or self-acting to move on the second wiping surface.

It is also preferred that the wiping surface be continuous, and therefore form a coherent surface in the mathematical sense. At the same time it can be a particular aim that the wiping device contact the surface to be wiped exclusively with the wiping surface, because no wheels, drive belts or the like need be employed.

With the objects of the invention in view, there is also provided a unit for treating floors with a mobile device. The unit comprises a base station for regenerating the mobile device according to the invention. The base station has a motor-driven transport device for transporting the mobile device into the base station for regeneration and for transporting the mobile device out of the base station.

Thus, the present invention also relates to a unit for treating floors, which on one hand has a motor-driven device, that is designated below as a mobile device and which performs the actual treatment, and on the other hand has a base station, serving to replenish the mobile device at specific distances covered. The mobile device is therefore moved motor-driven over the floor area to be treated and returns at specific distances to the base station to be regenerated. The base station also has a motor-driven transport device, which is structured to transport the mobile device for regeneration into the base station and to transport it out of the base station.

The principle underlying the invention therefore relates to equipping the base station with a motor device for transporting the mobile device in and out, even though the mobile device itself is motor-driven. In contrast to conventional units, in which the mobile device moves through the use of its drive to the base station and “parks” for example on or under corresponding terminals for regenerating, the base station according to the invention is fitted with its own motor mechanism, the transporting device. In this way the mobile device is brought into a specific position, with respect to the structural configuration of the base station and the structural configuration of the mobile device and its drive itself, without consideration having to be made to the fact that the mobile device has to reach the appropriate position through the use of its own drive. By way of example, the transporting device of the base station according to the invention can also raise the mobile device, for which purpose its drive unit will in many cases not be in a standing position. In addition, the transporting device in the base station, if desired or required, can apply relatively large forces, which the motor drive unit of the mobile device, powered for example by an electric storage battery or the like, cannot apply or can apply only if this drive is in an unnecessarily spacious configuration.

The mobile device preferably has a wiping cloth, with which it wipes the floor for cleaning or for other reasons. The replenishing preferably includes the cleaning of the wiping cloth or the exchange of the wiping cloth for a cleaned or a new wiping cloth. The term “wiping cloth” is to be understood in a very general sense and can include all possible fiber-based flat products, with which a floor can be wiped. These can therefore be non-woven fabrics, rags, lapped or paper-like textiles and the like.

In one embodiment of the invention, the base station contains an oblique plane, on which replenishing of the mobile device takes place and to which the mobile device is thus brought by the transporting device. The oblique plane can ensure better access to the underside of the mobile device and facilitate cleaning or exchange of a wiping cloth or any other replenishing.

The motor-driven transporting device of the base station contains at least one and preferably two levers, constructed to grip the mobile device. The gripped mobile device is then pulled into or lifted into the base station by the lever.

The lever or both levers are preferably fitted with a mechanism, which latches onto correspondingly formed recesses of the mobile device, when the latter is gripped. In the process, the locking should preferably be released in the base station in the further course of transport of the mobile device, whereby the lever can also act to guide the transporting in the base station after the locking is released.

By way of example, the lock mechanism can be a spring-loaded pin coupling. The joining pins can engage behind a corresponding recess and lock onto an undercut. The joining pins are preferably provided on the levers and the recess with the undercut on the mobile device. The spring-loaded joining pins can be released from the locking by a further mechanical device in the base station, or also by an oblique plane on the device of the base station with the undercut, over which oblique plane the pins can run up when correspondingly directed forces are exerted. Thereafter, the pins can for example run along in a groove without further undercut to thus serve as a guide.

The base station cleans the mobile device preferably as follows: it guides it over a squeezing roller, by which the cleaning fluid still contained in a wiping cloth or previously applied for cleaning the wiping cloth is pressed out of the wiping cloth, so that any associated dirt is removed at the same time. In the same manner this applies also for pressing out the treatment fluids which do not contribute to the cleaning. The squeezing roller is pressed onto the mobile device with a preferably adjustable pressure. By way of example, the squeezing roller can be mounted eccentrically or the guide mechanisms for the mobile device can be adjustable relative to the squeezing roller.

It is also preferred to newly moisten the wiping cloth with a cleaning fluid or other fluid following this pressing out. In a particular embodiment, cleaning fluid is used, which is reused in the base station, and was therefore squeezed out or expressed at an earlier point in time. At the same time the base station can have a filter, in particular a continuous operation filter, for the cleaning fluid.

For one, the new moistening can also serve through renewed squeezing out or expressing to repeat and improve the cleaning. Secondly, it can be desired to dampen the wiping cloth prior to fresh wiping of the floor or to actually wet it. It is preferred in particular that the cleaning unit also carry out a two-stage or multi-stage wiping procedure, in that the mobile device first wipes relatively wet and then absorbs the fluid still on the floor.

Furthermore, the base station can be fitted with an additional device enabling a wiping cloth to be exchanged, in which it is taken out of an adhesive closure (a so-called inclined closure or similar) on the mobile device. At this point, further work is carried out using a new or respectively cleaned wiping cloth, re-applied to the adhesive closure. This happens in this particular embodiment automatically through the use of the base station.

With the unit according to the invention, the degree of soiling or dirtiness of the floor to be cleaned, of the used wiping cloth, of the cleaning fluid in the base station and/or of the filter for the cleaning fluid, can be measured and monitored, which takes place preferably through respective optical or opto-electronic measures.

Other features which are considered as characteristic for the invention are set forth in the appended claims.

Although the invention is illustrated and described herein as embodied in an inertia drive device, a unit having the device and a method for moving the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a highly diagrammatic, elevational view illustrating the principle of an inertia drive according to the invention;

FIG. 2 is a view similar to FIG. 1 illustrating the principle of a variant of the device of FIG. 1;

FIG. 3 is an elevational view of a wiping device according to the invention with an alternative inertia drive;

FIG. 4 shows the wiping device of FIG. 3 in another state of movement;

FIG. 5 shows an alternative to the wiping device of FIGS. 3 and 4;

FIG. 6 is a fragmentary, top-plan view of a portion of FIGS. 3, 4 and 5;

FIG. 7 is a diagrammatic illustration of a further alternative inertia drive;

FIG. 8 is a plan view showing yet another diagrammatic illustration of an alternative inertia drive;

FIG. 9 is an elevational view of an example of a wheel drive;

FIG. 10 is an exploded, front-elevational view of a wiping device;

FIG. 11 is an elevational view illustrating the principle of a base station according to the invention;

FIG. 12 is a more detailed side-elevational view of a base station according to the invention;

FIG. 13 is an enlarged, fragmentary view of a portion of FIG. 12;

FIG. 14 is an elevational view showing further details of a base station according to the invention; and

FIG. 15 is an elevational view showing additional details of a base station according to the invention.

### DESCRIPTION OF THE PREFERRED EMBODIMENTS

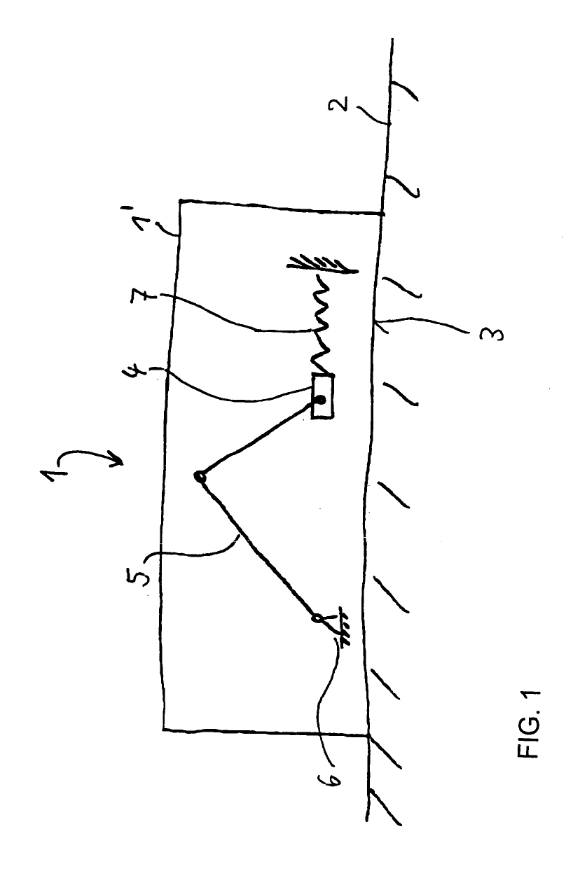

Referring now to the figures of the drawings in detail and first, particularly, to FIG. 1 thereof, there is seen a highly diagrammatic illustration of the principle of an inertia, flywheel, centrifugal or gyrating drive according to the invention. In FIG. 1 a wiping device for moist wiping and thus cleaning of floors in a household or in other inside rooms is designated with reference numeral 1. The wiping device 1 is illustrated in FIG. 1 as having a base 1′ in the from of a simple box. The wiping device 1 lies on a floor 2 and faces the latter with a wiping surface 3.

An inertia or centrifugal mass 4, which is provided in the wiping device 1 and is only symbolically illustrated in this case, is disposed in such a way as to be movable and horizontal in a manner that is not illustrated in greater detail. In the present case, as is likewise only symbolically illustrated, the inertia or gyrating mass 4 is powered by a lever system 5 from a drive motor 6 and against the force of a spring 7. The drive motor 6 thus tensions the spring 7 to the right to a certain point, whereupon a release mechanism decouples the inertia or flywheel mass 4 from the force of the drive motor or releases the drive motor 6. At this point the spring 7 can accelerate the inertial mass 4 relatively quickly and to the left in FIG. 1. During this acceleration phase, a reaction force results on the base, i.e. the remainder of the wiping device 1, which accelerates the wiping device 1 to the right against static friction between the wiping surface 3 and the floor 2, as seen in FIG. 1.

Due to the sliding friction between the wiping surface 3 and the floor 2, this movement is braked again after a certain glide path. The spring 7 has in the meantime further pushed the inertial mass 4 away, so that the drive motor 6 can move the inertial mass 4 to the right again through the lever system 5 to tension the spring 7. At the same time this results in such little acceleration of the inertial mass 4 to the right that tensioning of the spring 7 does not lead to complementary jerky movement of the wiping device 1 to the left. With iterative repetition of the above-described procedure, the wiping device 1 therefore skids to the right step-by-step between the wiping surface 3 and the floor 2 as the static friction is overcome. This accordingly explains the basic principle of the inertia drive, and in particular with respect to a linear movement of the inertial mass 4 according to a model example.

Alternatively, the movement of the inertial mass 4 could be used by the drive motor 6 as an inertial mass movement for the movement phase. The wiping device 1 would then therefore be moved step-by-step to the left. The spring 7 would be utilized in that case only as an energy storage device to return the inertial mass 4 to the starting position for renewed acceleration by the drive motor 6. The spring 7 represents energy storage of any type, which could also be electric (capacitors), for example. It should be noted that the energy for returning the movement does not necessarily have to originate from the drive motor 6.

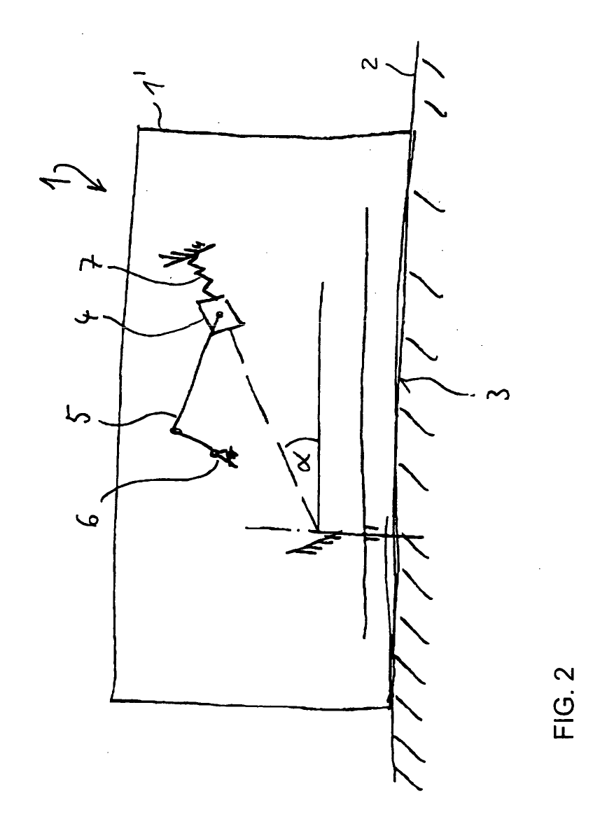

FIG. 2 shows a very similar model, in which the same reference numerals are used as in FIG. 1. The difference between the mechanics illustrated in FIG. 2 and those in FIG. 1 is in a tilting of the movement path of the inertial mass 4 relative to the horizontal about an angle α. The result thereof is that during acceleration of the inertial mass 4 by the spring 7, a reaction force or a recoil power acts on the wiping device 1, and this force is likewise tilted about the angle α relative to the horizontal. It therefore has a component acting against gravitational force. Therefore, not only a horizontal impulse directed to the right but also an impulse directed vertically upwards, act on the center of gravity of the wiping device 1. In concrete terms, the wiping device 1 becomes lighter in this movement phase, i.e. the resulting force effective for the friction between the wiping surface 3 and the floor 2 lessens. In this case, it should be pointed out that due to the layout of the inertia drive, influence can be made not only by intermittently greater and lesser deceleration and acceleration, but also through the direction thereof as to when the static friction is overcome and when it is not.

A further alternative to the functions illustrated by way of FIGS. 1 and 2 is to have the inertial mass 4 and the spring 7 describe self-oscillation as in a linear oscillator through the use of the drive motor 6, and preferably in a state close to resonance. In the variant of FIG. 2 which is inclined about the angle α, the desired adhesion phases and slide movement phases consequently result in a different influence on the static friction at the two return points of this oscillation. In the variant of FIG. 1, the inertial mass 4 could, for example, be braked relatively hard at one of the two return points, for example by a non-illustrated elastic wall or another comparatively harder spring. This would then result in correspondingly large deceleration forces, with which the static friction can be overcome.

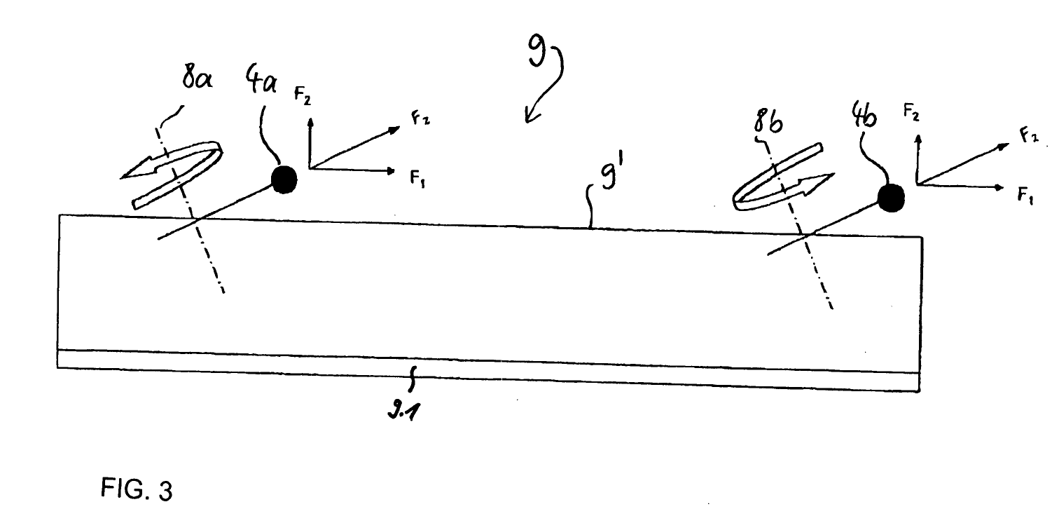

FIG. 3 illustrates another embodiment of an inertia drive. In this case, two inertial masses 4a and 4b are provided and mounted eccentrically and pivoting. Reference numerals 8a and 8b designate axes of rotation of their rotary movement. At the same time both inertial masses 4a and 4b rotate synchronously and in opposite directions. It is evident that the rotation planes and the axes of rotation 8a and 8b are inclined. The synchronous rotary movements of the inertial masses 4a and 4b are in each case isochronous in the uppermost (shown in FIG. 3) and in each case the lowermost vertex. In the uppermost vertex the centrifugal forces are thus added to a gravitation-reducing vertical component and a horizontal component. The horizontal components are in each case designated by reference symbol F₁ and the vertical components are in each case designated by reference symbol F₂. The canted centrifugal force is designated by reference symbol F_{Z}. The centrifugal force can thus move the wiping device, which is designated herein by reference numeral 9 and has a base 9′, by a specific slide path to the right. The wiping device 9 is provided with a wiping surface 9.1. In the lowest vertex of the rotation paths of the inertial masses 4a and 4b in each case the centrifugal forces are also added, however in this case they reinforce the essential force of the wiping device 9 and the vertical component of centrifugal force with respect to the static friction force resulting from gravity. The inertial forces are compensated at least partially in the remaining area of the respective paths through opposite rotation of the two inertial masses 4a and 4b, so that the static friction likewise is not exceeded there. The slide phase relates rather only to a specific temporal environment of the state in FIG. 3. Appropriate construction, i.e. matching between the friction coefficients, the masses, radii and speeds as well as path tilting angles of the inertial masses 4a and 4b, can result in the wiping device 9 lying straight in these deepest vertices as a result of static friction. In this embodiment the iterative glide phases can therefore be achieved by continuous circular movement of the inertial masses.

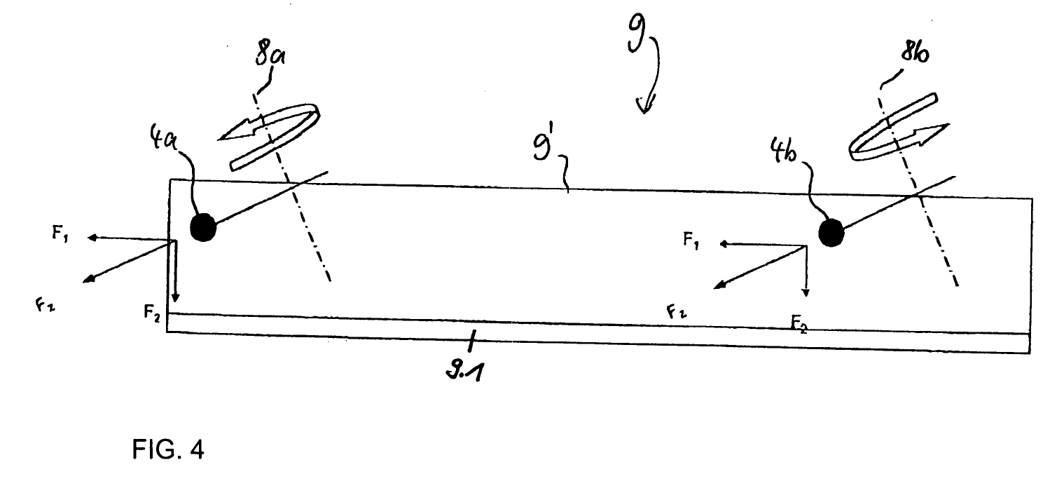

FIG. 4 shows the idle phase. In this case, the inertial masses are in each case in the deepest vertex of the respective circular movement.

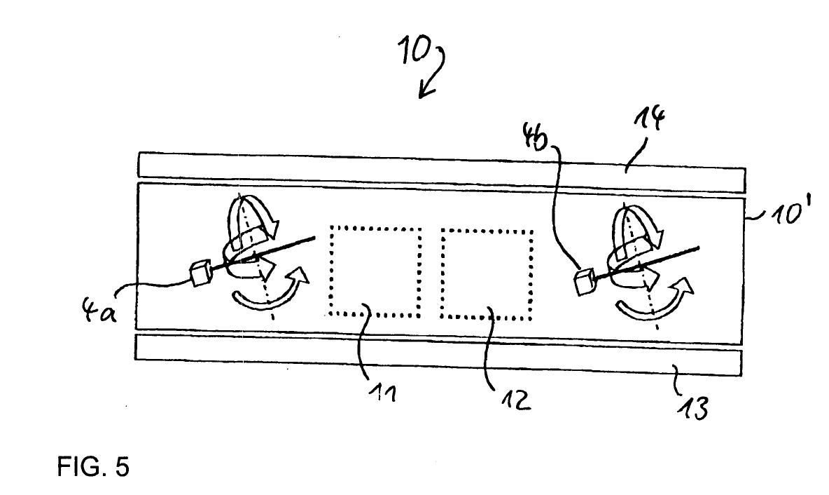

FIG. 5 shows yet another wiping device 10 with a base 10′ and an inertia drive, which is only symbolically illustrated in this case and which corresponds to the description given for FIGS. 3 and 4. An electronic control 11 with a microprocessor for programming the wiping device, a storage device, an assessment device for position and acceleration sensors or for collision sensors, disposed on side edges of the wiping device 10, although not illustrated, as well as electronics for monitoring power electronics, which are designated by reference numeral 12 and controlling charging and discharging procedures of electrical storage batteries and a motor drive of the inertial masses 4a and 4b, are also symbolically illustrated. One of skill in the art is fully familiar with the electrotechnical details of such a control. The focus of the invention herein is rather on the functioning of the inertia drive.

In the illustrated state, the wiping device 10 of FIG. 5 furthermore not only has on its underside a wiping cloth 13 with an underside which forms a temporarily used wiping surface, but on its upper side it has a further unused wiping cloth 14. The wiping cloth of the wiping device 10 can therefore either be reversed by the user by hand, or by a base station described in detail below, to be able to wipe further with the second wiping cloth 14, if the first wiping cloth 13 is soiled or worn. The wiping device illustrated in this case has a numerical ratio at the edges in projection on the floor of approximately over 3:1. This allows narrow interstices to be thoroughly cleaned on one hand, and achieves effective web widths on large surfaces on the other hand.

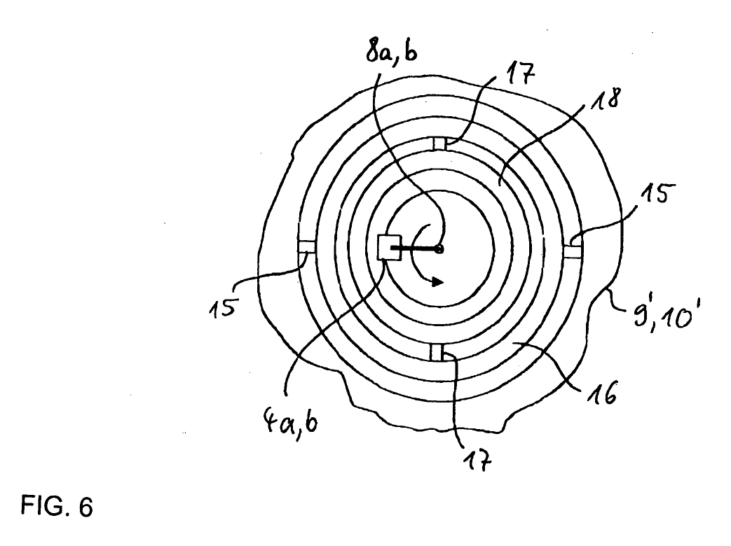

FIG. 6 is a plan view which illustrates a cardanic configuration of the inertial masses 4a and 4b of FIGS. 3 to 5. A “fixed” base of the corresponding wiping device is indicated by reference numerals 9′ and 10′. The direction of sight is from above onto the floor plane. A first rotating shaft 15 holds a first cardanic ring 16, on which a second rotating shaft 17 is applied, which is shifted relative to the first rotating shaft 15 by 90°. The second rotating shaft 17 holds a second cardanic ring 18, on which the respective inertial mass 4a or 4b is pivotally mounted about the axis of rotation 8a to 8b. The motor drive unit of the respective inertial mass 4a or 4b is preferably provided by electromotors provided in the cardan bearings or through flexible shafts, which are advanced by motors attached solidly to the base 9, 10, but which are not illustrated. The cardanic configuration with the shafts 15 and 17 can likewise be adjusted by (non-illustrated) servomotors through a lever system with levers set on the rings 16, 18 on the respective rotating shaft 15 or 17.

It follows along with the description of FIGS. 3 to 5 given above, that the wiping device 9, 10 can adapt to different friction ratios between respective wiping cloths or other wiping surfaces and different floors, even when these are dependent on direction, by adjusting the rotation speeds and the rotation planes. In particular, the electronic control 11 can detect when the wiping device 9, 10 is moved and for example through increasing tilting of the rotation planes can strive for a state in which the static friction is overcome phasewise but still prevails phasewise. In addition, the wiping device 9 and 10 can be moved in any horizontal direction as a result of the cardanic bearing configuration. It can easily also be imagined that turning the wiping device 9, 10 about a vertical axis can be attained by separate control of the rotation planes and/or the rotation phases of the two inertial masses 4a and 4b, in that the centrifugal force of the inertial masses is reversed at a maximal gravitation-reducing vertical component or superpositions with gravitation on both sides are different. Any superpositions from rotational movements and translatory movements can naturally also be achieved.

In order to provide an angular momentum drive, gyroscopes with a concentric center of gravity would have to be envisaged in FIG. 3 and in the following figures instead of the eccentrically suspended inertial masses. Their angular momentum could lie, for example, substantially horizontally and could act, through jerky changes relative to the original position, as angular momentum acting on the base with a vertical direction. This vertical angular momentum could turn a part of the wiping device. If at the same time an angular momentum component with horizontal direction provides for weighting an end, this could serve as an axis of rotation for a swiveling movement of the wiping device. Thereafter a further step could be made with reverse direction and at the corresponding other end of the wiping device with weighting, also resulting in this case in an iterative progressive motion possibility.

The drives described are all disposed within and thus above the wiping surface.

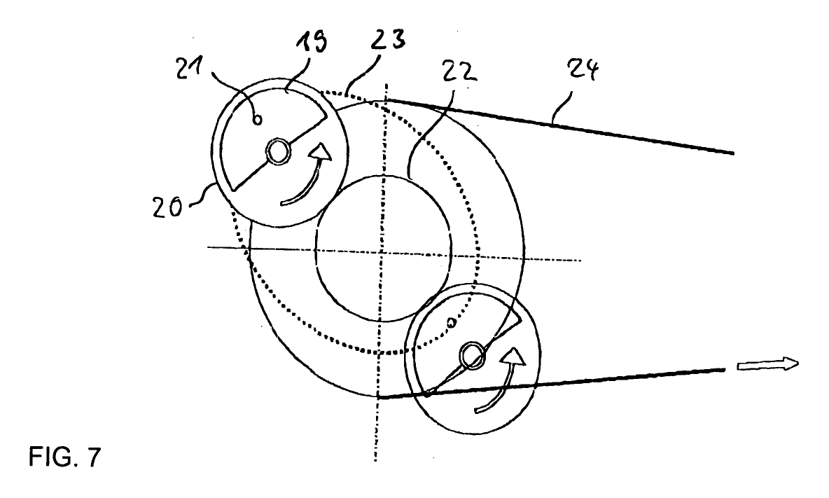

FIG. 7 shows a further rotary movement of an inertial mass 19. The inertial mass 19 is connected eccentrically in a planet wheel 20, in which the center of gravity is designated by reference numeral 21. The planet wheel 20 runs on a fixed sun wheel 22. The middle point of the planet wheel describes a circular trajectory, however the center of gravity 21 describes an elliptical path 23 indicated in dashed lines. In the present case it can be envisaged that a rotating shaft of the planet wheel 20 is driven by a belt drive designated by reference numeral 24. FIG. 7 helps to clarify the fact that centrifugal force of varying magnitudes at different times can be achieved with the curve of the center of gravity of the inertial mass. Apart from this, the path speed itself of the inertial mass can naturally also be accelerated or decelerated in its path movement. In addition, the above-mentioned possibilities of mutual compensation of inertial forces of two or more inertial masses are taken into consideration.

As a result of aligning the longitudinal axis of the elliptical path in FIG. 7, this drive unit would already produce an inertial drive even without canting the path plane and with only one inertial mass 19.

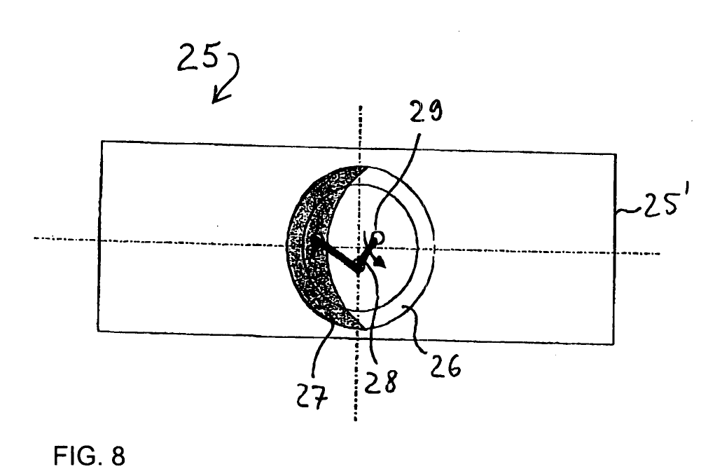

FIG. 8 shows a further example illustrating the principle of a possibility of an inertia drive. A wiping device shown in plan view is indicated diagrammatically by reference numeral 25 and has a base 25′. Within a bearing 26 provided in the wiping device 25 is an eccentric sickle-shaped inertial mass 27 that is guided for rotation. A movement of the inertial mass 27 can be achieved by a lever system (double crank with link) 28 through a motor connected at a point 29. This movement is uneven with uniform motor speed and correspondingly also leads to an inertial drive of the wiping device 25 with glide phases and adhesion phases.

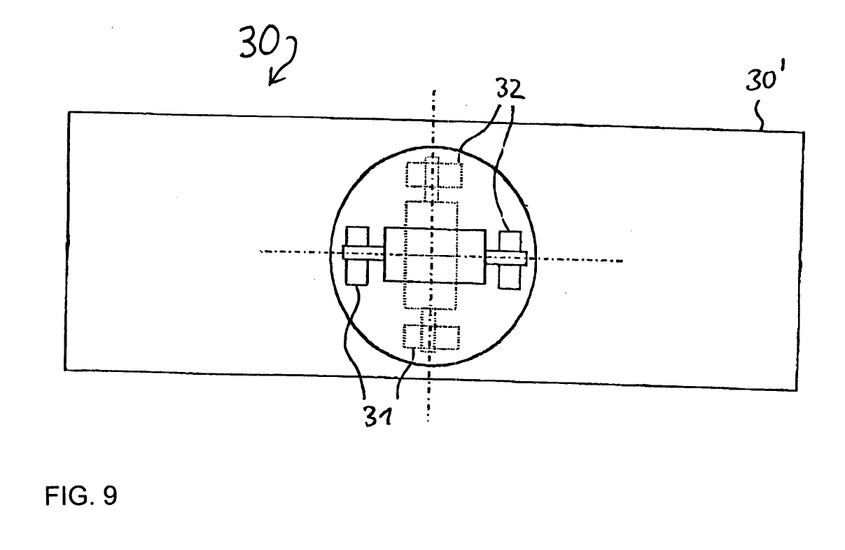

FIG. 9 shows an alternative drive, which is not an inertia drive. In this case, a wheel drive which is provided inside a wiping device 30 having a base 30′ is disposed inside the wiping surface (as is seen in the plan view of the wiping device 30 of FIG. 9), in which two wheels 31 and 32 can be driven independently of one another and can be turned relative to the wiping device 30. The wheels are shown in two different positions, however there are two wheels in all. The wiping device 30 with its wiping surface can thereby be transported across the floor, whereby any direction of movement as well as rotations of the wiping device 30 about its own axis can be achieved by way of differences in speed between the wheels 31 and 32 and by a motor adjustment of the angles of the axis of rotation of the wheels 31 and 32 relative to the wiping device 30. At the same time it must be ensured that a positive or force-locking between the wheels 31 and 32 and the floor is adequately high in relation to the slide friction of the wiping surface.

FIG. 9 shows in particular that with this drive unit a configuration inside the wiping surface is also possible and tracks appearing on the floor which are possibly caused by the wheels 31 and 32 can be wiped away later independently of the direction of movement. The wiping surface is namely a surface closed in around the drive unit.

In particular, in connection with the wheel drive, it can be provided for the wiping surface to oscillate relative to the rotation of the drive unit or in some other way, in order to heighten the mechanical cleaning action. An inertial mass can also be used for this purpose. In addition, the inertia drives can naturally be correspondingly supplemented in the different examples.

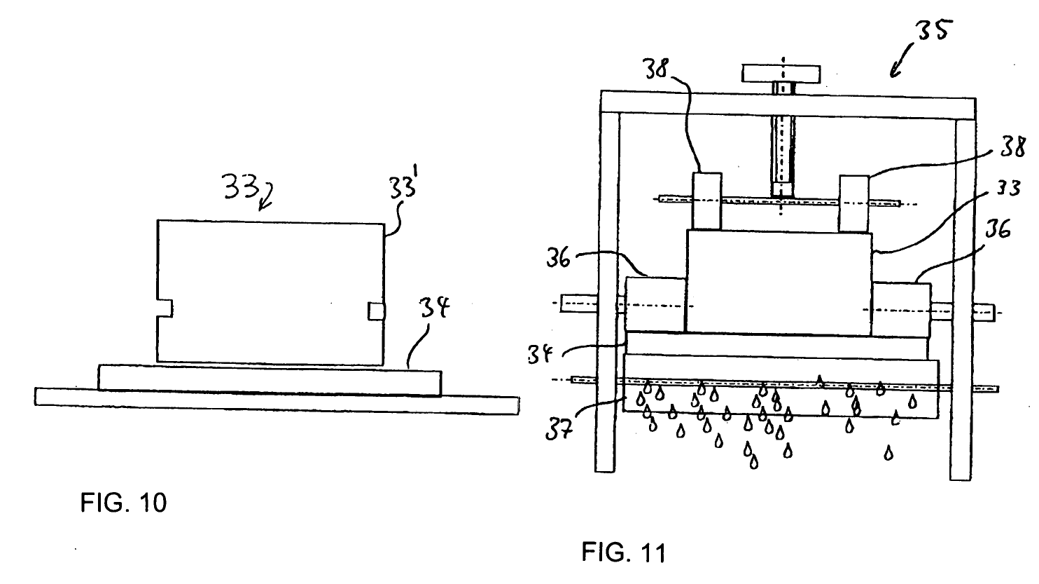

FIG. 10 is a front view of a wiping device 33 having a base 33′, which has a wiping cloth 34 projecting over the lateral edge of the actual wiping device 33. This wiping cloth 34 acts as an edge protection and also delimits the dimensions of the wiping device 33 in projection onto the floor. This allows, in particular, especially efficient wiping along wall edges, without the danger of damage as a result of an impact to the wiping device 33. The wiping devices according to the invention can naturally and correspondingly also have impact protection edges independently of wiping cloths, which additionally can take on sensory tasks in order to inform the above-mentioned electronic control 11 of a collision with an obstacle.

FIG. 11 is a cross-sectional view taken along the line of sight of FIG. 10, illustrating the principle of a base station 35 according to the invention for regenerating the wiping device 33. The wiping device 33 with the wiping cloth 34 is guided between squeezing rollers 36, 37, 38. The distance between the squeezing rollers 36 and 37 as well as between the squeezing rollers 38 and 37 is adjustable, so that the force, with which the wiping cloth 34 is squeezed out, can be determined in an appropriate manner. The squeezing rollers 38 press on the wiping device 33 itself and the squeezing rollers 36 press on the projecting edges of the wiping cloth 34, with the squeezing rollers 37 forming a counter bearing at the same time. The squeezed cleaning fluid flows away downwards as indicated.

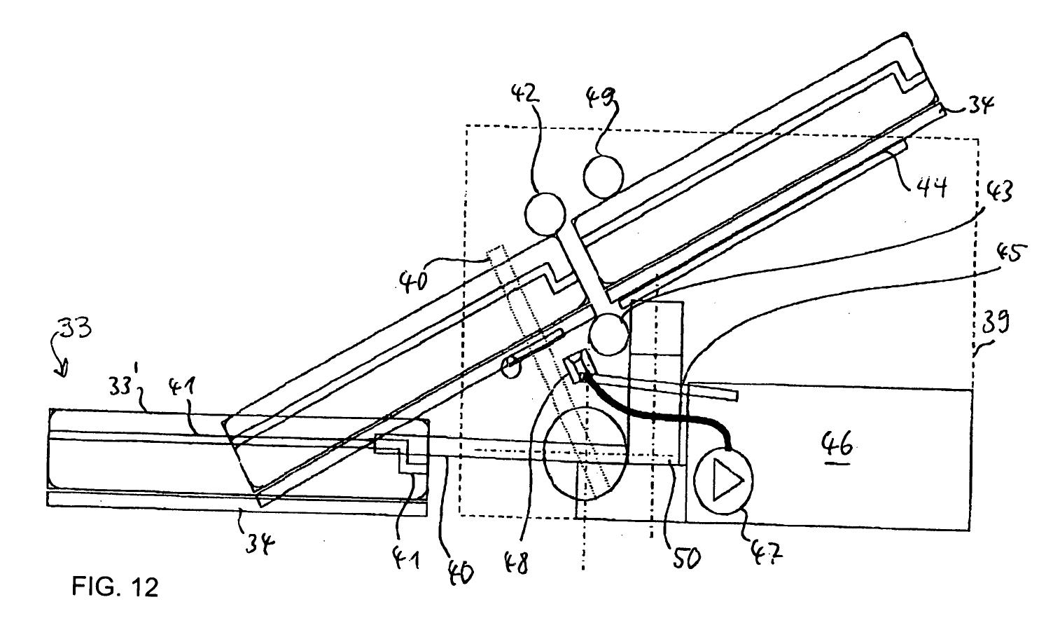

FIG. 12 shows a somewhat more concrete embodiment for the base station, which is designated herein by reference numeral 39. The wiping device 33 of FIG. 10 or, for example, the wiping device 10 of FIG. 5 or the wiping device 9 of FIG. 3, can be driven through the use of its own drive into a position illustrated to the left in FIG. 12. There they are gripped by two levers 40, which can be tilted by a motor as illustrated. At the same time spring-loaded pins, which are explained in greater detail below, are latched behind undercuts in grooves 41 seen in FIG. 12 in respective front regions of longitudinal sides of the wiping device 33. The lever 40 can thus grip the wiping device 33 and can lift and tilt it in the illustrated manner, so that the front end of the wiping device 33 is guided in between squeezing rollers 42 and 43. The squeezing rollers 42 and 43 draw the wiping device 33 further obliquely upwards, whereby the pilot pins unlatch from catches and instead run on in the grooves 41 as a guide. The wiping device 33 is transported in this way to an oblique plane 44, whereby the squeezing rollers 42 and 43 squeeze out any residual moisture remaining in the wiping cloth 34.

The draining cleaning fluid flows away through a continuous filter 45 into a waste-water reservoir 46, from which correspondingly cleaned cleaning fluid is supplied via the filter 45 through the use of a pump 47 to a nozzle 48, which then sprays the cleaning fluid to improve cleaning prior to squeezing out and/or when the wiping device 33 returns to the wiping cloth 34. The transport of the wiping device 33 is also supported by an additional transport roller 49. A fresh-water reservoir 50 which is also provided contains, for example, clear fresh water for subsequent wiping and for rinsing and accordingly can be attached to the nozzle 48 in a non-illustrated manner. The cleaning unit can carry out multiple, first wet and then dry wiping in the manner already described.

The oblique movement of the wiping device 33 on the plane 44 enables easy transport of the wiping device 33 through the use of the motor-driven lever 40 into the base station 39. The underside and thus the wiping cloth 34 of the wiping device 33 become accessible and space is made for the above components under the plane 44. A hydraulic unit on the continuous filter 45, the waste-water reservoir 46 and the nozzle 48 as well as the fresh-water reservoir 50 can be removed in their entirety as a module.

The distances between the rollers 42 and 49 relative to the roller 43 are also adjustable for ensuring optimal squeezing out and adequate positive or force-locking for transport. This means that the residual moisture in the cleaning cloth 34 can also be adjusted. The adjustment can be carried out, for example, by eccentric cams in rotating shaft bearings.

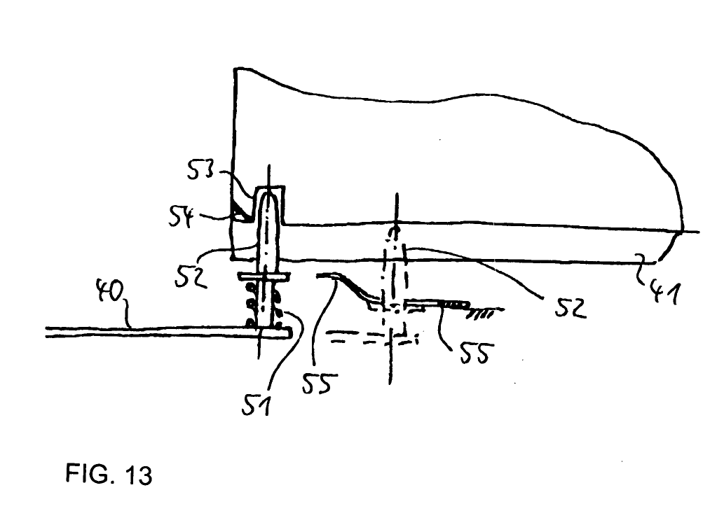

FIG. 13 illustrates the above-mentioned latch mechanism for gripping the wiping device 33 by the lever 40. The end of one of the two levers 40, which is seen at the lower left, carries a pin 52 spring-loaded by a spring 51. It should be noted that FIG. 13 is laterally transposed as compared to FIG. 12. Therefore, it is seen that in its initial region, in the vicinity of its right end in FIG. 12 and left end in FIG. 13, the above-mentioned groove 41 has an undercut 53, in which the pin 52 can latch. Locking in place is facilitated by a bevel 54 at the front of the groove 41. Unlocking from the undercut can occur either through a similar bevel through the use of the forces exerted by the squeezing rollers 42 and 43 or through the use of further mechanical uncoupling, which is indicated herein by a motor-driven fork 55. The fork can grasp the pin 52 and draw it out from the undercut 53. Thereafter the pin 52 glides along the groove 41 as a guide.

There are also other possibilities, of course, to transport the wiping device 33 motor-driven into a base station, possibly through portals, cranes, elevators, chain drives, pull ropes and the like. In particular, a base station can also be constructed to turn a wiping device with two wiping cloths (see FIG. 5) through 180°.

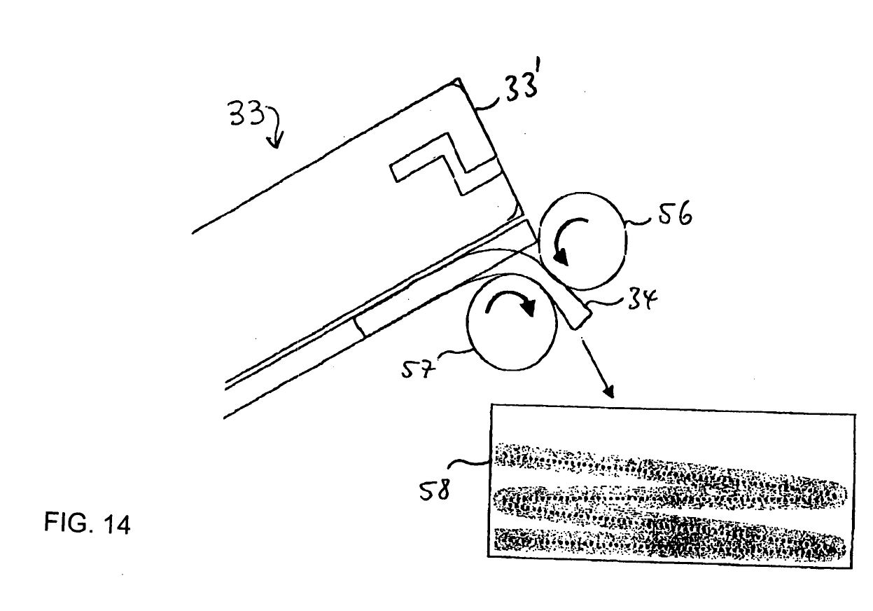

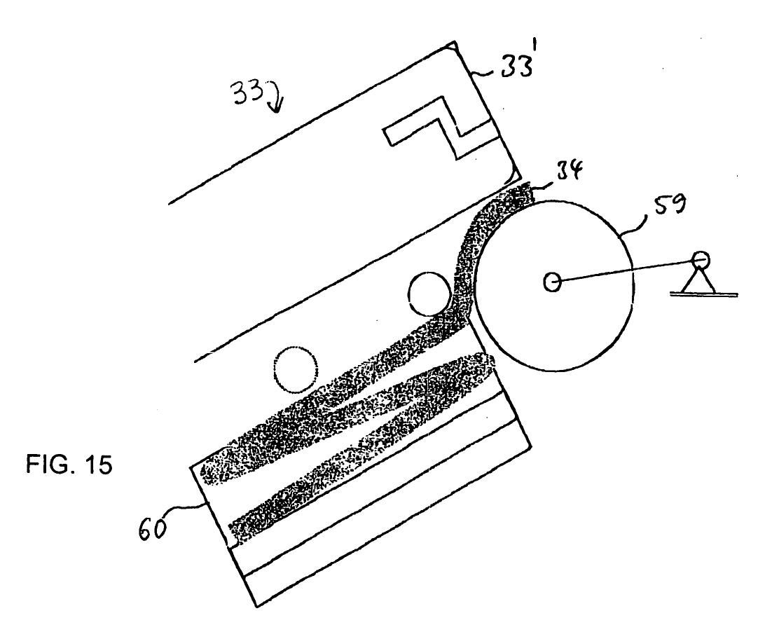

FIG. 14 diagrammatically shows that in a second compartment the base station 39 can also serve for changing the wiping cloth 34. FIG. 14 shows how the wiping cloth 34 is pulled out by two rollers 56 and 57 from inclined closures (which are not illustrated in greater detail) on the lower face of the wiping device 33 and laid into a container 58. FIG. 15 shows, in reverse order, how the wiping cloth 34 or a fresh wiping cloth 34 can be removed by a press roller 59 from a container 60 and applied to an adhesive closure. With both procedures transport of the wiping device 33 comparable to the explanations regarding FIG. 12 takes place in an oblique direction. Lever mechanics corresponding to the explanations of FIG. 12 can also be employed.

The different motor-actuated movement steps in the base station 39 can be controlled by light barriers or similar sensors. As soon as the wiping device 33 is grasped, the typical current flows of the connected electromotors can also be utilized to draw conclusions about the respective movement phases.

Optical evaluations of the degree of contamination of the floor, of the wiping cloth, the cleaning fluid in the wiping cloth or in the container 46, of the degree of contamination of the filter 45 and similar factors, can be used, as already mentioned.

In addition to this, the base station 39 can be programmable for inputting specific residual moistures, cleaning cycles, wiping cloth data and the like. Wiping cloths may also contain transponders, which are read out into the base station.

The electronic control 11 of the wiping device, which can also be reprogrammed by electronic control of the base station, can control the wiping device (in whichever actual construction) under consideration of known data or data of room dimensions and floor characteristics gathered on earlier runs. The user can also specify the rooms to be cleaned and thus call up known data sets or respectively input essential features of such rooms. In addition, the wiping device can perform automatic positioning, by known odometric processes, in that the movement distances and directions are ascertained and thus the current positions are determined. Ascertaining position can naturally also occur by some other manner, for example by laser measuring systems.

The wiping runs are preferably S-shaped with a preferably identical forward-lying lengthways edge. In this way large surfaces can be cleaned with few runs and minimal overlapping of the acquired web widths. The above-described movement with a constant leading edge effectively prevents dirt streaks from being deposited in curves or corners.

1. A device, comprising:
a base; and
a drive for moving said base over a surface, said drive having a motor-driven inertial mass movable relative to said base;
said drive driving said base by executing movements of said inertial mass relative to said base;
said drive overcoming static friction holding said base on the surface by mass inertia of said inertial mass in a part of said movements of said inertial mass, and said drive not overcoming static friction holding said base on the surface in another part of said movements of said inertial mass;
said drive causing said movements of said inertial mass relative to said base to be altogether iterative.

2. The device according to claim 1, wherein said movements of said inertial mass are linear relative to said base.

3. The device according to claim 2, which further comprises an energy storage device connected to said inertial mass for absorbing energy from said movements and putting energy into said movements.

4. The device according to claim 1, wherein said movements of said inertial mass are rotary relative to said base.

5. The device according to claim 4, wherein said movements of said inertial mass are circular.

6. The device according to claim 4, wherein the center of gravity of said inertial mass experiencing said movements is eccentric relative to said rotary movements, and said drive uses centrifugal forces of said inertial mass in said rotary movements.

7. The device according to claim 4, wherein the center of gravity of said inertial mass experiencing said movements is concentric relative to said rotary movements, and said drive utilizes angular momentum of said inertial mass in said rotary movements.

8. The device according to claim 1, wherein said drive influences the static friction by using inertial force components of said movements of said inertial mass, perpendicular to the surface.

9. The device according to claim 8, wherein said inertial mass movements describe a path having an adjustable inclination.

10. The device according to claim 9, wherein said inertial mass is suspended on said base by a cardanic suspension.

11. The device according to claim 10, wherein said cardanic suspension can be shifted by motor.

12. The device according to claim 1, wherein said inertial mass is one of two motor-driven inertial masses movable relative to said base.

13. The device according to claim 12, wherein said two inertial masses rotate counter to one another.

14. The device according to claim 6, wherein said drive moves said base over straight stretches by stepwise translatory individual movements.

15. The device according to claim 8, wherein said drive moves said base over straight stretches by stepwise translatory individual movements.

16. The device according to claim 12, wherein said drive moves said base over straight stretches by stepwise translatory individual movements.

17. The device according to claim 7, wherein said drive moves said base over straight stretches through stepwise rotary individual movements with alternating directions and axes of rotation.

18. The device according to claim 8, wherein said drive moves said base over straight stretches through stepwise rotary individual movements with alternating directions and axes of rotation.

19. The device according to claim 12, wherein said drive moves said base over straight stretches through stepwise rotary individual movements with alternating directions and axes of rotation.

20. The device according to claim 1, wherein the device is a treatment device for floors.

21. The device according to claim 1, wherein the device is a device for wiping flat surfaces, said base has a wiping surface covering a web width, and said drive lies inside said web width during movement of said base by said drive.

22. A unit for treating floors with a mobile device, the unit comprising:
a base station for regenerating the mobile device according to claim 1;
said base station having a motor-driven transport device for transporting the mobile device into said base station for regeneration and for transporting the mobile device out of said base station.

23. A method for moving a device over a surface, which comprises the following steps:
executing movements of the inertial mass relative to the base with the motor drive of the device according to claim 1;
overcoming static friction holding the device onto the surface by mass inertia of the inertial mass in a part of the movements of the inertial mass, and not overcoming the static friction holding the device onto the surface in another part of the movements of the inertial mass; and
moving the device over the surface by iterative movements of the inertial mass relative to the base.
